(19) United States
(12) Patent Application Publication
(10) Pub. No.: US 2004/0128283 A1
(43) Pub. Date: Jul. 1, 2004

(54) Data exchange and mating method of handheld interactive device

(76) Inventors: Jih-Shiun Wang, Taipei (TW); I-Wen Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/331,467

(22) Filed: Dec. 31, 2002

(51) Int. Cl. G06F 7/00; G06F 17/30

(52) U.S. Cl. 707/3

(57) ABSTRACT

The present invention provides a data exchange and mating method of a handheld interactive device. The handheld interactive device comprises a personal database, a transmission/reception unit, an interpersonal database, a mating database, an analyzing and mating unit, and an output unit. The data exchange and mating method comprises the steps of: connecting to a handheld interactive device of another person and receiving the personal data of the other person; storing the personal data of the other person into the interpersonal database; comparing and analyzing the personal data of user and the personal data of the other person with the mating data of personality and compatibility to generate a mating result; and displaying the mating result on the output unit.

### FIELD OF THE INVENTION

The present invention relates to a data exchange and mating method of a handheld interactive device and, more particularly, to a handheld electronic device having a method for transmission and exchange of personal data and mating analysis of personality and compatibility.

### BACKGROUND OF THE INVENTION

Nowadays, many problems, like the fortune-telling, career perspective, and love affair problems, still need to be solved with conventional knowledge. There are still many persons believing in star signs and horoscope match. Some men and women even inquire about the date of birth and blood type of the other side and start associating with one another only if they are matched. Otherwise, if they find that they are not matched after starting associating with one another, adaptation and compensation ex post facto is difficult. Additionally, similar problems also occur in interpersonal and vocational relations.

Presently, an individual owns many handheld electronic devices (e.g., mobile phone, personal digital assistant, and electronic dictionary), most of them having personal data of user built therein. However, there is no data exchange and interactive functions designed in the above handheld devices. If each handheld device has functions of personal data exchange and mating of personality and compatibility built therein, there will be much help in the processing of interpersonal relations and love affair of user.

### SUMMARY OF THE INVENTION

Accordingly, the primary object of the present invention is to provide a data exchange and mating method of a handheld interactive device. The present invention is characterized in that the handheld interactive device at least comprises a personal database for storing personal data of user, a transmission/reception unit for transmitting personal data of user and receiving personal data of another person, an interpersonal database for storing personal data of other persons received by the transmission/reception unit, a mating database for storing mating data of personality and compatibility, an analyzing and mating unit for comparing and analyzing personal data of user and personal data of the other person to obtain mating data of personality and compatibility in the mating database and then generating a mating result, and an output unit for displaying the mating result generated by the analyzing and mating unit.

The secondary object of the present invention is to provide a data exchange and mating method of a handheld interactive device, whose real-time data exchange and mating method at least comprises the steps of: connecting to a handheld interactive device of another person and receiving his personal data; storing the personal data of the other person into an interpersonal database; comparing the personal data of user and the personal data of the other person to obtain mating data of personality and compatibility and then generating a mating result; and displaying the mating result on an output unit.

Another object of the present invention is to provide a data exchange and mating method of a handheld interactive device, whose data exchange and off-line mating method at least comprises the steps of: connecting to handheld interactive devices of several other persons and receiving their personal data one by one; storing the personal data of the other persons into an interpersonal database; the user selecting to compare the personal data of user and the personal data of another person stored in the interpersonal database or the personal data of any two other persons stored in the interpersonal database at any time after being off-lined to obtain mating data of personality and compatibility and then generating a mating result; and displaying the mating result on an output unit.

The various objects and advantages of the present invention will be more readily understood from the following detailed description when read in conjunction with the appended drawing, in which:

### BRIEF DESCRIPTION OF THE DRAWINGS

FIG. 1 is a data exchange architecture of a handheld interactive device of the present invention;

FIG. 2 is a circuit block diagram according to an embodiment of the present invention;

FIG. 3 is a flowchart of data exchange and real-time mating according to an embodiment of the present invention; and

FIG. 4 is a flowchart of data exchange and off-line mating according to an embodiment of the present invention.

### DETAILED DESCRIPTION OF THE PREFERRED EMBODIMENTS

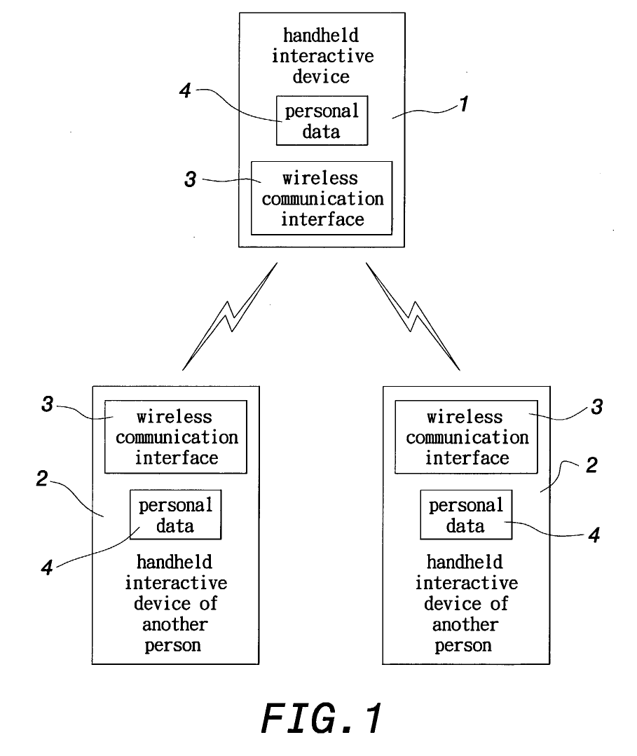

As shown in FIG. 1, a handheld interactive device 1 of the present invention can connect to a handheld interactive device 2 of another person to exchange personal data 4 with the other by using a wireless communication interface 3, thereby proceeding analysis of personal data between them and generating mating information of personality and compatibility. The user can thus know the personality of the other person and whether it is suitable for them to associate with each other. The personal data includes name, date of birth, gender, blood type, marital status, telephone number, address, email address, company, job position, and picture. The wireless communication interface 3 includes communication interfaces utilizing communication techniques like radio-frequency (RF) communication or infrared (IR) communication, but is not limited by them.

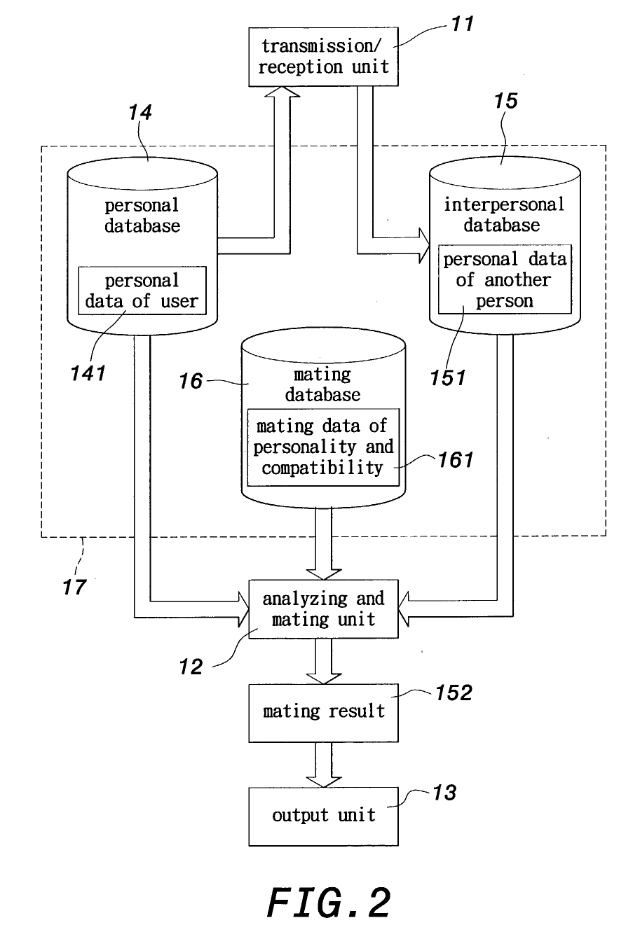

As shown in FIG. 2, the handheld interactive device 1 according to an embodiment of the present invention comprises a transmission/reception unit 11, an analyzing and mating unit 12, and an output unit 13. This embodiment of the present invention also comprises three kinds of databases: a personal database 14, an interpersonal database 15, and a mating database 16. The personal database 14 is used for storing personal data 141 of user of the handheld interactive device 1. The interpersonal database 15 is used for storing personal data 151 of another person transmitted from the handheld interactive device 2 of the other person. The mating database 16 is used for storing mating data of personality and compatibility 161. For those skilled in the art, the above three kinds of databases can be disposed in a memory unit 17 composed of one or several storages to be contained in the handheld interactive device 1.

In the embodiment of the present invention, the transmission/reception unit 11 is used for transmitting personal data 141 of user and receiving personal data 151 of another person and then storing the received personal data 151 of the other person into the interpersonal database 15. The analyzing and mating unit 12 is used for analyzing and comparing the personal data 141 of user and the personal data 151 of the other person with the mating data of personality and compatibility 161 in the mating database 16 and then generating a mating result 152. Finally, the mating result 152 is displayed via the output unit 13.

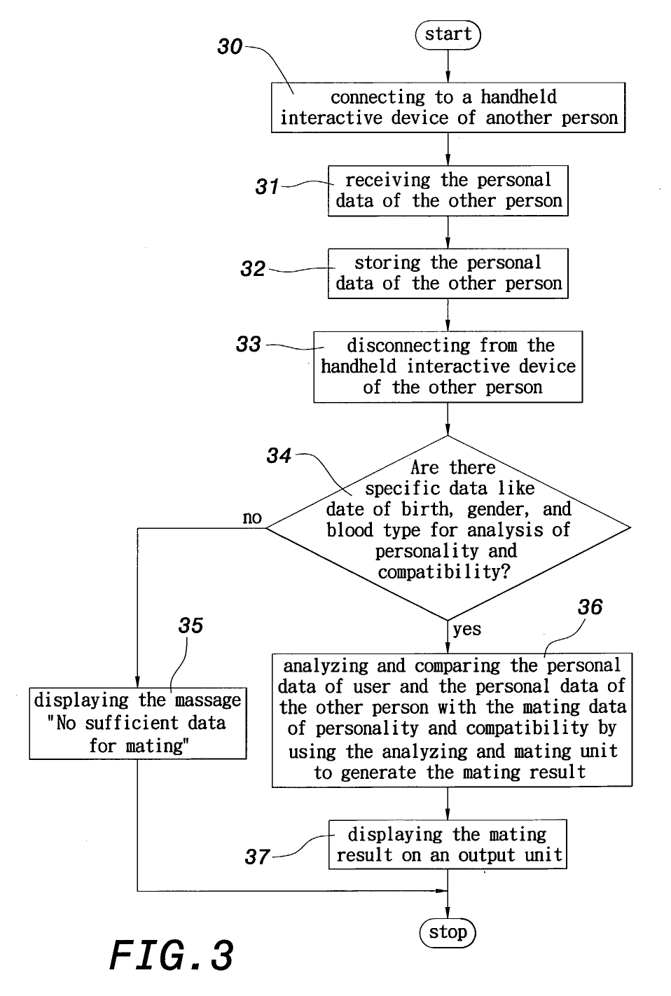

As shown in FIG. 3, a data exchange and real-time mating method according to an embodiment of the present invention at least comprises the steps of:

Step 30: connecting to the handheld interactive device 2 of another person;

Step 31: receiving the personal data 151 of the other person from the handheld interactive device 2 of the other person;

Step 32: storing the personal data 151 of the other person into the interpersonal database 15;

Step 33: disconnecting from the handheld interactive device 2 of the other person;

Step 34: checking the personal data 141 of user and the personal data 151 of the other person to see whether there are specific data like date of birth, gender, and blood type for analysis of personality and compatibility; proceeding Step 36 if the answer is positive, proceeding Step 35 otherwise;

Step 35: displaying the massage “No sufficient data for mating” on the output unit 13 and ending the mating flowchart;

Step 36: analyzing and comparing the personal data 141 of user and the personal data 151 of the other person with the mating data of personality and compatibility 161 to generate the mating result 152 (including text data, image data, or multimedia audio/video data); and

Step 37: displaying the mating result 151 on the output unit 13 and ending the mating flowchart.

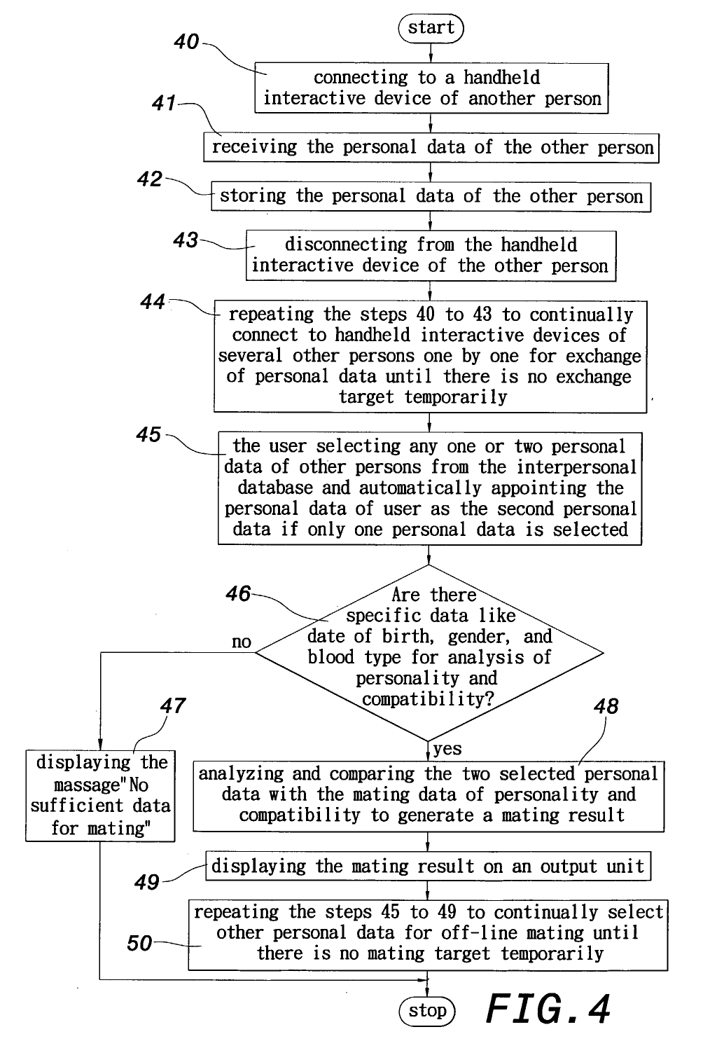

As shown in FIG. 4, in the embodiment of the present invention, the handheld interactive device 1 can first connect to handheld interactive devices 2 of several other persons one by one for exchange of personal data 4. The user can then arbitrarily select personal data in the device for analysis and mating one by one after being off-lined. The data exchange and off-line mating method at least comprises the steps of:

Step 40: connecting to the handheld interactive device 2 of another person;

Step 41: receiving the personal data 151 of the other person from the handheld interactive device 2 of the other person;

Step 42: storing the personal data 151 of the other person into the interpersonal database 15;

Step 43: disconnecting from the handheld interactive device 2 of the other person;

Step 44: repeating the steps 40 to 43 to continually connect to handheld interactive devices 2 of several other persons one by one for exchange of personal data until there is no exchange target temporarily;

Step 45: the user selecting the personal data 151 of any one or two other persons from the interpersonal database 15, automatically appointing the personal data 141 of user as the personal data of the second person if only the personal data of another person is selected;

Step 46: checking the personal data of the two selected persons to see whether there are specific data like date of birth, gender, and blood type for analysis of personality and compatibility; proceeding Step 48 if the answer is positive, proceeding Step 47 otherwise;

Step 47: displaying the massage “No sufficient data for mating” on the output unit 13 and then proceeding Step 50;

Step 48: the analyzing and mating unit 12 analyzing and comparing the personal data 141 of the two selected persons with the mating data of personality and compatibility 161 to generate the mating result 152 (including text data, image data, or multimedia audio/video data);

Step 49: displaying the mating result 151 on the output unit 13; and

Step 50: repeating the steps 45 to 49 to continually select other personal data for off-line mating, and then ending the mating flowchart until there is no mating target temporarily.

To sum up, the data exchange and mating method of a handheld interactive device of the present invention can provide a wireless function of exchange of personal data and analysis and mating of personality and compatibility. The present invention can thus let the user conveniently know the personality of other persons and interpersonal behavior modes to enhance compatibility between both sides and among the group. Moreover, the user can even find valuable friendship and successful marriage, and promote interpersonal and vocational relationship.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A data exchange and mating method of a handheld interactive device, said handheld interactive device having a personal data of user and a mating data of personality and compatibility, said data exchange and mating method at least comprising the steps of:
(a) a handheld interactive device transmitting its personal data of user and receiving a personal data of another person in a handheld interactive device of the other person;
(b) storing said personal data of the other person into an interpersonal database;
(c) analyzing and comparing said personal data of user and said personal data of the other person with said mating data of personality and compatibility to generate a mating result; and
(d) displaying said mating result on an output unit.

2. The data exchange and mating method of a handheld interactive device as claimed in claim 1, wherein said personal data of user is stored in a personal database, said mating data of personality and compatibility is stored in a mating database including mating data between different dates of birth, genders, and blood types, and said personal data of the other person is stored in an interpersonal database.

3. The data exchange and mating method of a handheld interactive device as claimed in claim 1 further comprising the step of connecting to a handheld interactive device before said Step (a) and the step of disconnecting from said handheld interactive device after said Step (b).

4. The data exchange and mating method of a handheld interactive device as claimed in claim 1 further comprising before said Step (c) the step of checking said personal data of user and said personal data of the other person to see whether there are data like date of birth, gender, blood type, or their any combinations, and proceeding said Step (c) if the answer is positive, while displaying the massage “No sufficient data for mating” on said output unit otherwise.

5. A data exchange and mating method of a handheld interactive device, said handheld interactive device having a personal data of user and a mating data of personality and compatibility, said data exchange and mating method at least comprising the steps of:
(a) a handheld interactive device transmitting its personal data of user and receiving a personal data of another person in a handheld interactive device of the other person;
(b) storing said personal data of the other person into an interpersonal database;
(c) repeating said steps (a) to (b) to continually exchange data with handheld interactive devices of several other persons one by one until there is no exchange target temporarily;
(d) the user selecting any one or two personal data of other persons from said interpersonal database;
(e) analyzing and comparing said two selected personal data of other persons with said mating data of personality and compatibility to generate a mating result;
(f) displaying said mating result on an output unit; and
(g) repeating said steps (d) to (f) to continually select personal data of other persons for mating until there is no mating target temporarily.

6. The data exchange and mating method of a handheld interactive device as claimed in claim 5, wherein said personal data of user is stored in a personal database, said mating data of personality and compatibility is stored in a mating database including mating data between different dates of birth, genders, and blood types, and said personal data of the other person is stored in an interpersonal database.

7. The data exchange and mating method of a handheld interactive device as claimed in claim 5 further comprising the step of connecting to a handheld interactive device before said Step (a) and the step of disconnecting from said handheld interactive device after said Step (b).

8. The data exchange and mating method of a handheld interactive device as claimed in claim 5, wherein said personal data of user in said handheld interactive device is automatically appointed as the second selected personal data of other persons if only the personal data of another person in said interpersonal database is selected in said step (d).

9. The data exchange and mating method of a handheld interactive device as claimed in claim 5 further comprising before said Step (e) the step of checking said personal data of user and said personal data of the other person to see whether there are data like date of birth, gender, blood type, or their any combinations, and proceeding said Step (f) if the answer is positive, while displaying the massage “No sufficient data for mating” on said output unit otherwise.

10. A data exchange and mating method of a handheld interactive device capable of letting a user exchange personal data with a handheld interactive device of another person, said handheld interactive device at least comprising:
a personal database for storing personal data of user;
a transmission/reception unit for transmitting personal data of user and receiving personal data of another person;
an interpersonal database for storing personal data of other persons received by said transmission/reception unit;
a mating database for storing mating data of personality and compatibility between different dates of birth, genders, and blood types;
an analyzing and mating unit for comparing and analyzing two personal data with the mating data of personality and compatibility in said mating database to generate a mating result; and
an output unit for displaying the mating result generated by said analyzing and mating unit.

11. The data exchange and mating method of a handheld interactive device as claimed in claim 10, wherein said personal database, said interpersonal database, and said mating database are disposed in a memory unit composed of one or several storages.

12. The data exchange and mating method of a handheld interactive device as claimed in claim 10, wherein said transmission/reception unit is a communication interface utilizing communication techniques like radio-frequency communication or infrared communication for exchanging data with other handheld interactive devices.
